(19) United States
(12) Patent Application Publication
(10) Pub. No.: US 2014/0305224 A1
(43) Pub. Date: Oct. 16, 2014

(54) MULTI-TOUCH TESTING SYSTEM AND FIXTURE THEREOF

(71) Applicant: WISTRON CORPORATION, New Taipei City (TW)

(72) Inventors: Xiao-Bao ZHANG, New Taipei City (TW); Shou-Lun CHANG, New Taipei City (TW)

(73) Assignee: WISTRON CORPORATION, New Taipei City (TW)

(21) Appl. No.: 14/180,485

(22) Filed: Feb. 14, 2014

(30) Foreign Application Priority Data
Apr. 16, 2013 (CN) 201310132060.4

(51) Int. Cl. G01N 3/08

(52) U.S. Cl. CPC G01N 3/08
USPC 73/818

(57) ABSTRACT

The present disclosure provides a multi-touch testing system and the fixture thereof. The multi-touch testing system comprises a multi-touch testing fixture and a monitoring device. The monitoring device is connected electrically with the multi-touch testing fixture and a device under test disposed at the multi-touch fixture. Thereby, the monitoring device activates the multi-touch testing fixture. The multiple test heads of the multi-touch testing fixture press the device under test simultaneously. Meanwhile, the device under test generates at least a signal. The monitoring device judges if the device under test passes the multi-touch test according to the signal. The pressure of each test head of the multi-touch testing fixture according to the present disclosure is identical to that of any other. In addition, the structure is simplified.

### FIELD OF THE DISCLOSURE

The present disclosure relates generally to a touch testing system and the fixture thereof, and particularly to a multi-touch testing system and the fixture thereof.

### BACKGROUND OF THE DISCLOSURE

In the history of the development of electronic equipment, the emergence of the input interfaces such as keyboards, mice, and touch pads solves the problem of input control. Nonetheless, these input interfaces occupy substantial spaces. For example, the keyboard occupies a half of the volume of a notebook computer or a cell phone. If the space for keyboards can be saved, the portability of products can be certainly improved. The most feasible method is to operate on the panel directly through touch controls. Touch panels surely can replace most functions of keyboards and mice; they also provide users with more intuitive and convenient operating experience. By replacing the keyboards with larger panels, lighter, thinner, and more fashionable designs can be further delivered. In addition, thanks to the completely solid-state panel technology, it is not necessary to worry about the failure problem of mechanical components such as keyboards or wheelers.

Technically, touch panels can be categorized into resistive, capacitive, infrared, surface acoustic wave, electromagnetic, and optical touch panels. By considering endurance, costs, response speed, and convenience, resistive and capacitive touch panels has become the mainstream in the market.

Recently, owing to their considerate touch interfaces, smartphones are favorable for many people. The emergence of multi-touch functions even results in new revolution in user interface. Users can use multi-touch electronic products more intuitively.

The single-touch testing fixture according to the prior art uses an actuator, such as a motor or an oil cylinder, to drive a test head for performing single-touch testing. If the testing method is used for testing a multi-touch panel, multiple actuators are required for driving the corresponding test heads for performing multi-touch testing. Because the test head are not connected to each other and are driven by different actuators, the pressure of each test head on the panel is not uniform with that of any other. Besides, the structure of the overall testing fixture is complicated; it has larger volume and occupies large space.

Accordingly, the present disclosure provides a multi-touch testing system and the fixture thereof. A plurality of test heads of the multi-touch testing system and the fixture thereof are disposed on a movable frame. Then at least a driving module is used for driving the movable frame, which drives the plurality of test heads simultaneously. The pressure of each of the plurality of test heads on the panel is identical to that of any other. Thereby, the testing fixture is simplified.

### SUMMARY

An objective of the present disclosure is to provide a multi-touch testing system and the fixture thereof. The multi-touch testing fixture allows multiple test heads to press on a device under test simultaneously for performing multi-touch testing.

Another objective of the present disclosure is to provide a multi-touch testing system and the fixture thereof. The multi-touch testing fixture allows the pressure of each test head on the device under test to be identical to that of any other. In addition, the structure of the multi-touch testing fixture is simple.

For achieving the objectives and effects described above, the present disclosure discloses a multi-touch testing fixture, which comprises a carrying platform, a movable frame, a plurality of test heads, and at least a driving module. The carrying platform carries a device under test. The movable frame is disposed on the carrying platform. The plurality of test heads are disposed on the movable frame and corresponding to a touch region of the device under test. The driving module drives the movable frame to perform reciprocating motion. The plurality of test heads press the touch region simultaneously along with the motion of the movable frame.

The present disclosure provides a multi-touch testing system, which comprises a multi-touch testing fixture and a monitoring device. The multi-touch testing fixture carries a device under test. The monitoring device is connected electrically to the multi-touch testing fixture and the device under test. The monitoring device activates the multi-touch testing fixture, which performs multi-touch testing on the device under test. The device under test generates at least a signal and transmits the signal to the monitoring device. The monitoring device judges if the device under test passes the test according to the signal.

### BRIEF DESCRIPTION OF THE DRAWINGS

FIG. 1 shows a block diagram of the testing system according to the first embodiment of the present disclosure;

FIG. 2 shows a usage block diagram of the testing system according to the first embodiment of the present disclosure;

FIG. 3 shows a flowchart of the testing system according to the first embodiment of the present disclosure;

FIG. 4 shows a flowchart of the testing system according to the second embodiment of the present disclosure;

FIG. 5 shows a schematic diagram of the testing fixture according to the third embodiment of the present disclosure;

FIG. 6 shows a usage status diagram of the testing fixture according to the third embodiment of the present disclosure;

FIG. 7 shows a schematic diagram of the movable frame according to the third embodiment of the present disclosure;

FIG. 8 shows an assembly diagram of the movable frame assembled on the carrying platform according to the third embodiment of the present disclosure;

FIG. 9 shows an assembly diagram of the test heads assembled on the movable frame according to the third embodiment of the present disclosure;

FIG. 10 shows an assembly diagram of the region A in FIG. 8;

FIG. 11 shows a schematic diagram of the test head according to the third embodiment of the present disclosure;

FIG. 12 shows an assembly diagram of the driving module assembled on the movable frame according to the third embodiment of the present disclosure;

FIGS. 13A to 13E show usage status diagrams of the testing fixture according to the third embodiment of the present disclosure; and

FIG. 14 shows a schematic diagram of the testing fixture according the fourth embodiment of the present disclosure.

### DETAILED DESCRIPTION

In order to make the structure and characteristics as well as the effectiveness of the present disclosure to be further understood and recognized, the detailed description of the present disclosure is provided as follows along with embodiments and accompanying figures.

According to the prior art, when the single-touch testing fixture is adopted for performing multi-touch testing on a panel, the pressure of each test head on the panel is difficult to be kept identical to that of any other. Moreover, the structure of the testing fixture becomes complicated.

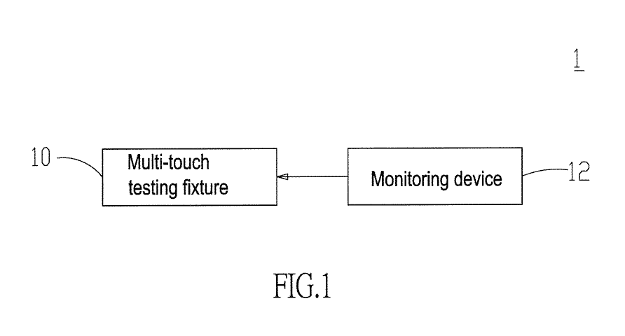

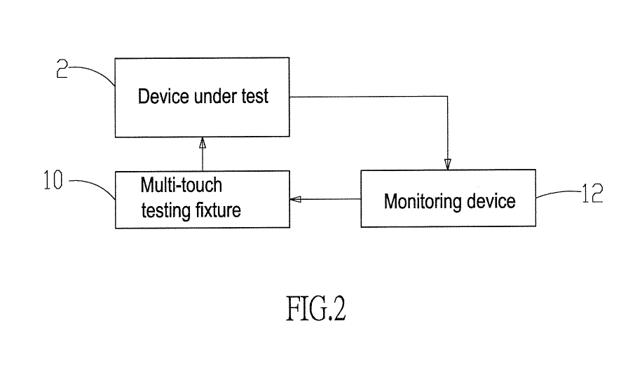

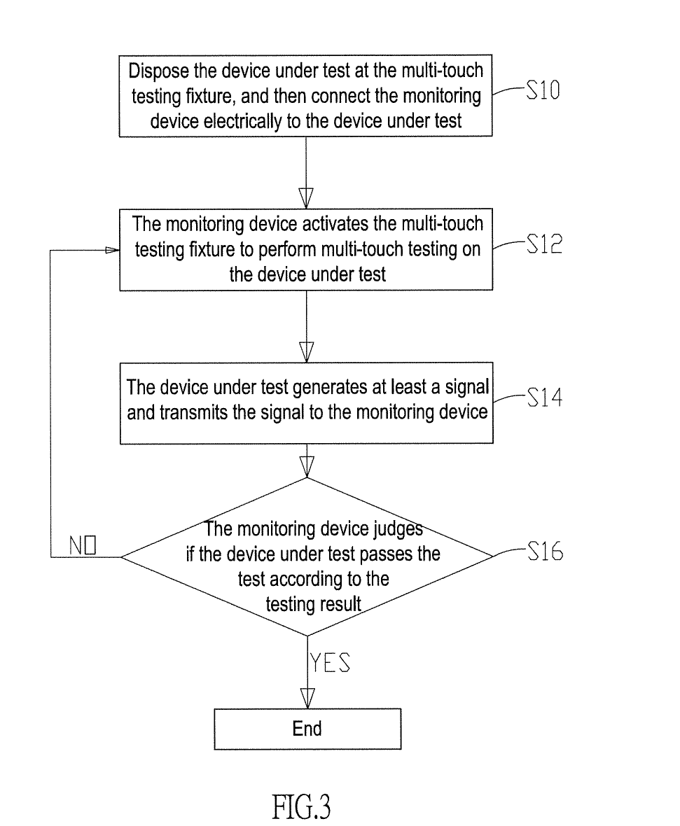

FIG. 1 shows a block diagram of the testing system according to the first embodiment of the present disclosure. As shown in the figure, according to the present embodiment, a multi-touch testing system 1 is provided. The multi-touch testing system 1 comprises a multi-touch testing fixture 10 and a monitoring device 12. The monitoring device 12 can be a computer connected electrically to the multi-touch testing fixture 10 for activating the multi-touch testing fixture 10 to perform multi-touch testing. Please also refer to FIG. 2 and FIG. 3, which show a usage block diagram and a flowchart of the testing system according to the first embodiment of the present disclosure. As shown in the figure, when the multi-touch testing system 1 performs multi-touch testing, the step S10 is first executed for disposing a device under test 2 at the multi-touch testing fixture 10. Then the monitoring device 12 is connected electrically to the device under test 2, which can be a touch panel or a notebook computer. If the device under test 2 is a touch panel, the monitoring device 12 is connected to a control circuit of the touch panel directly. If the device under test 2 is a notebook computer, the monitoring device 12 is connected to the connection port of the notebook computer for receiving the signal generated by the device under test 2.

Next, the step S12 is executed. The monitoring device 12 activates the multi-touch testing fixture 10 and enabling the multi-touch testing fixture 10 to perform multi-touch testing on the device under test 2. Then, the step S14 is executed. The device under test 2 generates at least a signal and transmits the signal to the monitoring device 12. Finally, the step S16 is executed. The monitoring device 12 produces a testing result according the signal generated by the device under test 2 and judges if the device under test 2 passes the test according to the testing result. The criterion of judging if the device under test 2 passes the test is whether the device under test 2 shows the multi-touch function after multiple presses without damages in the device under test 2. If so, it means that the device under test 2 has excellent pressure tolerance. If the monitoring device 12 judges that the device under test 2 fails to pass the test, the steps S12 to S16 are repeated for re-assuring if the testing result is correct. As the monitoring device 12 judges that the device under test 2 passes the test, the multi-touch test stops.

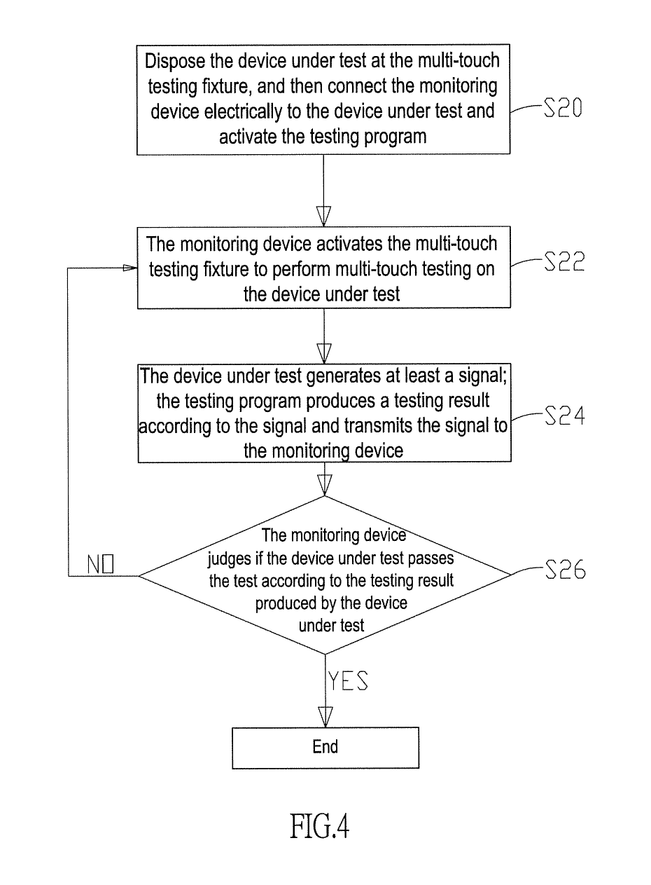

If the device under test 2 is a notebook computer, the present disclosure also provides another testing method. FIG. 4 shows a flowchart of the testing system according to the second embodiment of the present disclosure. As shown in the figure, before using the testing procedure of the present embodiment, a testing program should be installed in the device under test 2 first. While performing multi-touch testing, the step S20 is first executed for disposing the device under test 2 at the multi-touch testing fixture 10. Then the monitoring device 12 is connected electrically to the device under test 2 and the testing program is started. Next, the step S22 is executed. The monitoring device 12 activates the multi-touch testing fixture 10 and enabling the multi-touch testing fixture 10 to perform multi-touch testing on the device under test 2. Then, the step S24 is executed. The device under test 2 generates at least a signal; the testing program produces a testing result according the signal and transmits the signal to the monitoring device 12. Finally, the step S26 is executed. The monitoring device 12 judges if the device under test 2 passes the test according to the testing result. The difference between the testing procedure according to the present embodiment and the one according to the first embodiment is that according to the present embodiment, the device under test 2 itself can produce the testing result; the monitoring device 12 stops or continues the multi-touch testing according to the testing result directly without processing the signal generated by the device under test 2.

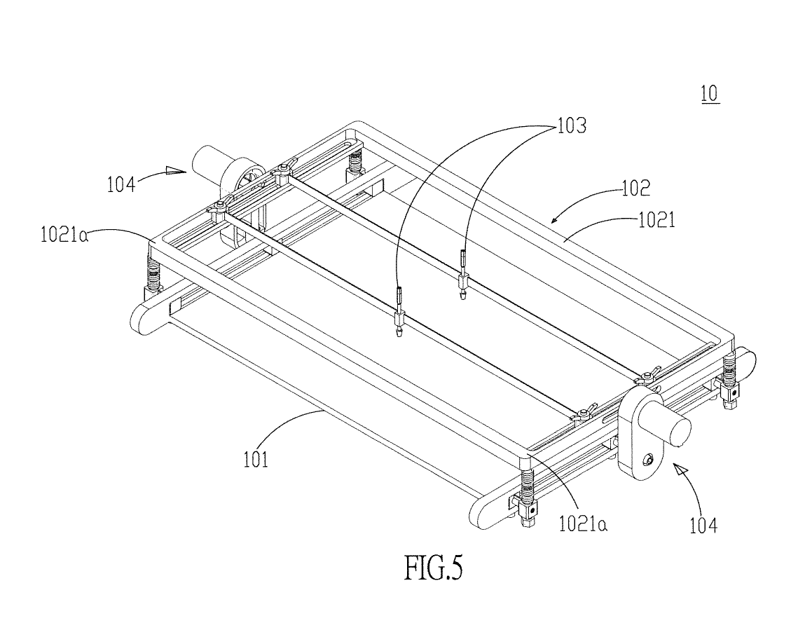

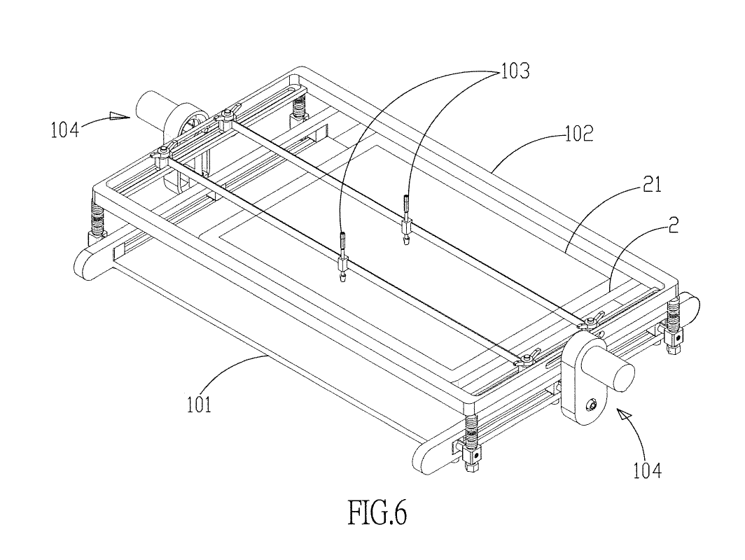

In the following, the structure of the multi-touch testing fixture 10 according to the present disclosure will be described in detail. FIG. 5 shows a schematic diagram of the testing fixture according to the third embodiment of the present disclosure. As shown in the figure, the multi-touch testing fixture 10 according to the present embodiment comprises a carrying platform 101, a movable frame 102, a plurality of test heads 103, and at least a driving module 104. The movable frame 102 is disposed on the carrying platform 101. The plurality of test heads 103 are disposed on the movable frame 102. The driving module 104 is disposed on the movable frame 102. Please refer to FIG. 6 as well. FIG. 6 shows a usage status diagram of the testing fixture according to the third embodiment of the present disclosure. As shown in the figure, when the multi-touch testing is performed on the device under test 2, the device under test 2 is first disposed on the carrying platform 101; a touch region 21 of the device under test 2 is located under the plurality of test heads 103. Then the driving module 104 is activated for driving the movable frame to do reciprocating motion, which means that the moving direction of the movable frame 102 is perpendicular to the touch region 21. The movable frame 102 drives the plurality of test heads 103 to press the touch region 21 simultaneously. The device under test 2 generates the corresponding signal, which can be used for judging if the device under test 2 passes the multi-touch testing.

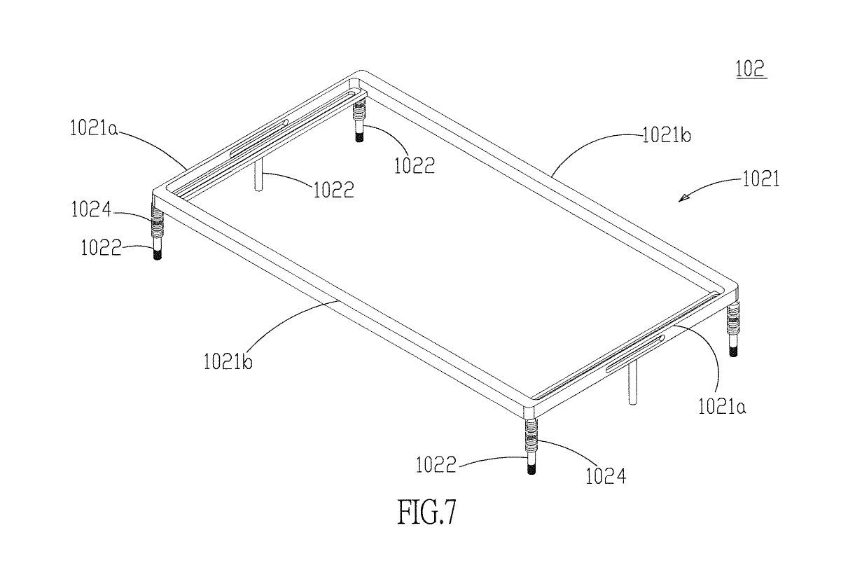

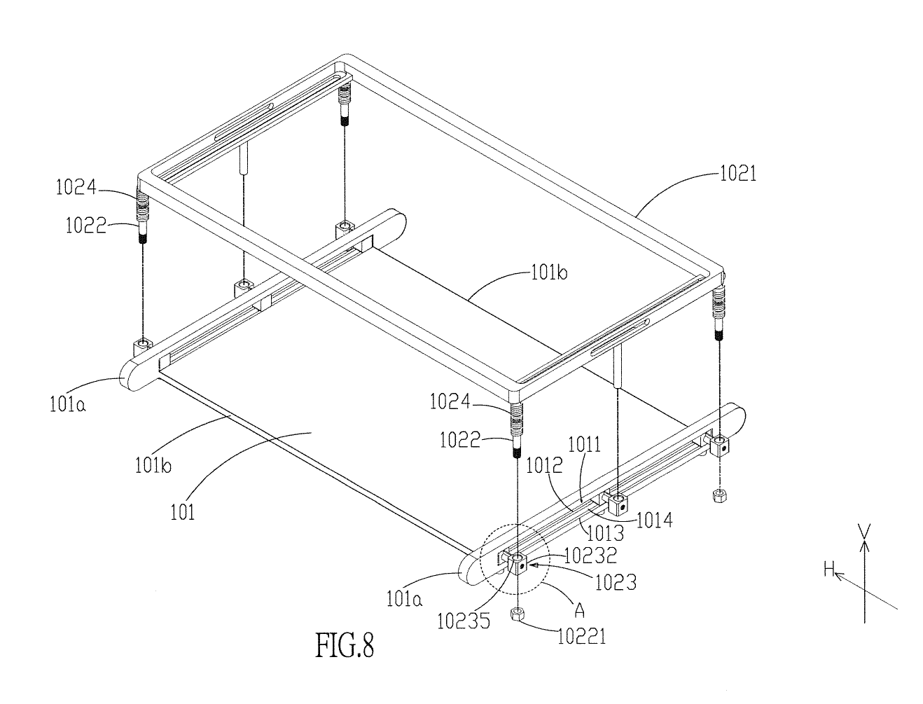

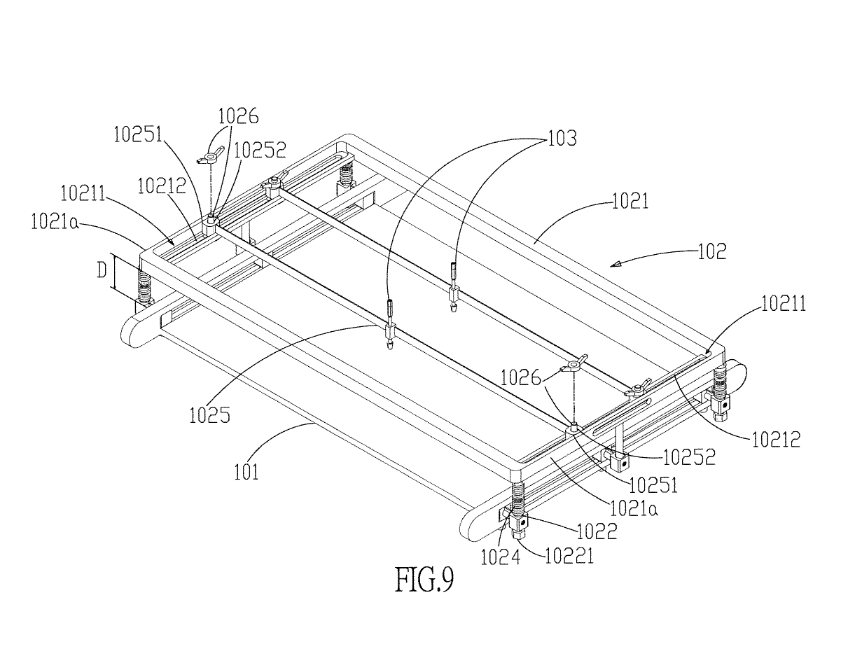

In the following, the structures and their connection of the movable frame 102, the test heads 103, and the driving module 104 are described in detail. Please refer to FIGS. 7 to 9. FIG. 7 shows a schematic diagram of the movable frame according to the third embodiment of the present disclosure; FIG. 8 shows an assembly diagram of the movable frame assembled on the carrying platform according to the third embodiment of the present disclosure; and FIG. 9 shows an assembly diagram of the test heads assembled on the movable frame according to the third embodiment of the present disclosure. As shown in the figures, the movable frame 102 comprises a rectangular frame 1021, a plurality of sliding pillars 1022, a plurality of fixing members 1023, a plurality of elastic members 1024, and at least a positioning member 1025. The frame 1021 has a pair of corresponding first sides 1021a and a pair of corresponding second sides 1021b. The plurality of sliding pillars according to the present embodiment are disposed on the two first sides 1021a of the frame 1021. The number of the plurality of sliding pillars 1022 on one first side 1021a is the same as that on the other. Besides, the plurality of sliding pillars 1022 on one first side 1021a correspond to those on the other. Moreover, four of the plurality of sliding pillars 1022 according to the present embodiment are just located at the four corners of the frame 1021.

The carrying platform 101 has two corresponding first sides 101a and two corresponding second sides 101b. The frame 1021 is fixed to the carrying platform 101 through the plurality of fixing members 1023. First, the plurality of fixing members 1023 are disposed on the two first sides 101a of the carrying platform 101, respectively, and corresponding to the plurality of sliding pillars 1022 on the two first sides 1021a of the frame 1021. The two first sides 101a of the carrying platform 101 have a first installation part 1011, respectively. The first installation part 1011 according to the present embodiment has a groove 1012. The groove 1012 has a first opening 1013 and a second opening 1014. The directions of the two first openings 1013 of the two first installation parts 1011 are horizontal H; the directions of the two second openings 1014 are vertical V. In addition, the two second openings 1014 are located at the bottom of the carrying platform 101.

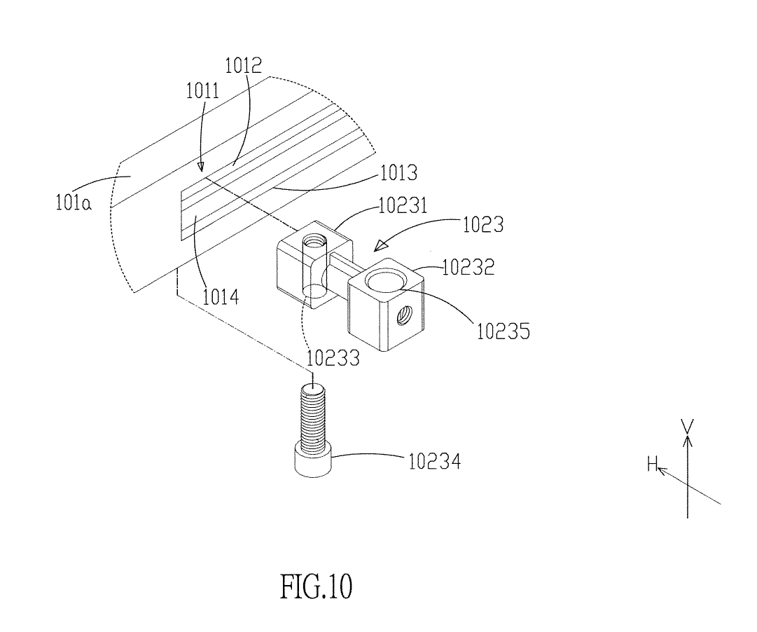

FIG. 10 shows an assembly diagram of the region A in FIG. 8. As shown in the figure, each fixing member 1023 has a first connecting part 10231 and a second connecting part 10232. The second connecting part 10232 is connected with the first connecting part 10231. When each fixing member 1023 is disposed on the two first sides 101a of the carrying platform 101, the first connecting part 10231 enters via the first opening 1013 and is fixed to the groove 1012 of the first installation part 1011. The second connecting part 10232 is located outside the carrying platform 101 and corresponding to the sliding pillar 1022 of the frame 1021. The first connecting part 10231 has a first hole 10233 corresponding to the second opening 1014. Then a first fastening member 10234 passes through the second opening 1014 and is fastened to the first hole 10233 for fixing the first connecting part 10232 in the groove 1012. The above description is only an embodiment of fixing the first connecting part 10231 to the groove 1012; other fixing methods can be adopted as well. The details will not be described further.

After the plurality of fixing members 1023 are disposed on the carrying platform 101, the frame 1021 is disposed on the carrying platform 101. The plurality of sliding pillars 1022 pass through the second connecting parts 10232 of the corresponding fixing members 1023. The second connecting part 10232 has a first hole 10235; the penetrating direction of the first hole 10235 is vertical V. Each sliding pillar 1022 penetrates the first hole 10235 of the corresponding second connecting part 10232 and sliding in the first hole 10235 for locating the frame 1021 above the carrying platform 101.

In order to support the frame 1021 above the carrying platform 101 and maintain a spacing D therebetween, according to the present embodiment, an elastic member 1024, such as a spring, is further dispose around each of the plurality of sliding pillars 1022 at the four corners of the frame 1021, respectively, and located between the fixing member 1023 and the frame 1021. The elastic members 1024 support the frame 1021 above the carrying platform 101 by means of their elasticity and thus keeping the spacing D between the frame 1021 and the carrying platform 101. In addition, the sliding pillar 1022, which has the elastic member 1024, has a stopping member 10221 located below the second connecting part 10232. As the sliding pillar 1022 moves upwards, the stopping member 10221 is blocked by the fixing member 1023 for preventing the sliding pillar 1022 from coming off the second connecting part 10232.

After the frame 1021 is disposed on the carrying platform 101, install the plurality of test heads to the movable frame 102. First, the plurality of test head 103 are disposed to the positioning members 1025. Then the fixing member 1023 is disposed to the frame 10121. A second installation part 10211 is disposed on each of the two first sides 1021a of the frame 1021, respectively. Each second installation part 10211 according to the present embodiment has a first penetrating groove 10212, which penetrates the corresponding first side 1021a. The positioning member 1025 has a fixing part 10251 at each of both ends, respectively; each fixing part 10251 has a second hole 10252. When the positioning member 1025 is disposed on the frame 1021, the two fixing parts 10251 of the positioning member 1025 are located above the corresponding second installation parts 1021, respectively, so that the second hole 10252 of each fixing part 10251 corresponds to the first penetrating groove 10212 of the second installation part 10211. Finally, two second fastening members 1026 pass through the corresponding second holes 10252 and the first penetrating groove 10212, respectively, for fixing the positioning member 1025 to the frame 1021. Thereby, the plurality of test heads 103, which are disposed at the positioning members 1025, correspond to the device under test located on the carrying platform 101.

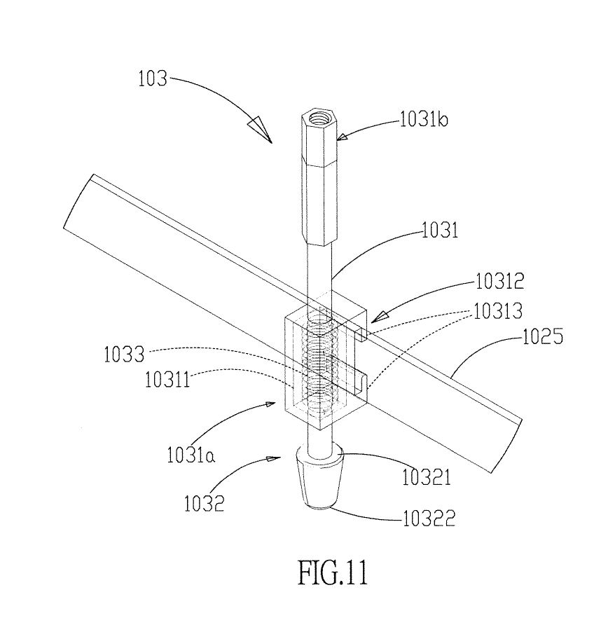

FIG. 11 shows a schematic diagram of the test head according to the third embodiment of the present disclosure. As shown in the figure, each test head 103 comprises a main part 1031, a pressing part 1032, and an elastic part 1033. The main part 1031 has a first end 1031a and a second end 1031b. The first end 1031a has an accommodating trench 10311 extending to the second end 1031b. The pressing part 1032 penetrates the accommodating trench 10311 of the main part 1031; the elastic part 1033 is disposed in the accommodating trench and against the pressing part 1032. As the pressing part 1032 is drawn back into the accommodating trench 10311, the elastic part 1033 can make pressing part 1032 drawn back in the accommodating trench 10311 stick out and recover to its original position.

Besides, the main part 1031 has a third fastening part 10312. The third fastening part 10312 according to the present embodiment includes a pair of hooks 10313 opposing to each other. When the test had 103 is disposed at the positioning member 1025, the two hooks 10313 of the test head 103 hook the positioning member 1025. According to the present embodiment, two positioning members 1025 are disposed on the frame 1021 with each positioning member 1025 having a test head 103. The numbers and locations of the positioning member 1025 and the test heads 103 can be adjusted according to users' requirements. For example, a single positioning member 1025 can be used; and a plurality of test heads 103 are disposed at the positioning member 1025. The details will not be described further.

The pressing part 1032 of each test head 103 described above comprises a main pressing body 10321 and a conductive member 10322. The main pressing body 10321 is made of metal, such as copper. The conductive member 10322 is disposed at the main pressing body 10321. In particular, the conductive member 10322 has to cover the surface of the main pressing body 10321 corresponding to the device under test. In other words, the conductive member 10322 corresponds to the touch region of the device under test. The material of the conductive member 10322 is conductive foam. Thereby, the plurality of test heads 103 can emulate the conduction when a person presses the device under test.

Refer again to FIG. 5. After the movable frame 102 is disposed on the carrying platform 101, at least a driving module 104 is disposed at the movable frame 102 for driving the movable frame to do reciprocating motion. Hence, the movable frame 102 can drive the plurality of test heads 103 to press the touch region of the device under test and thus performing multi-touch testing on the device under test. According to the present embodiment, two driving modules 104 are disposed. The two driving modules 104 are disposed on the two first sides 1021a of the frame 1021 of the movable frame 102, respectively, for driving the frame 1021 simultaneously. Thereby, the movable frame 102 can drive the plurality of test heads 103 to press the touch region of the device under test at the same time, which allows the values of the pressure on the device under test by the plurality of test heads 103 to be identical.

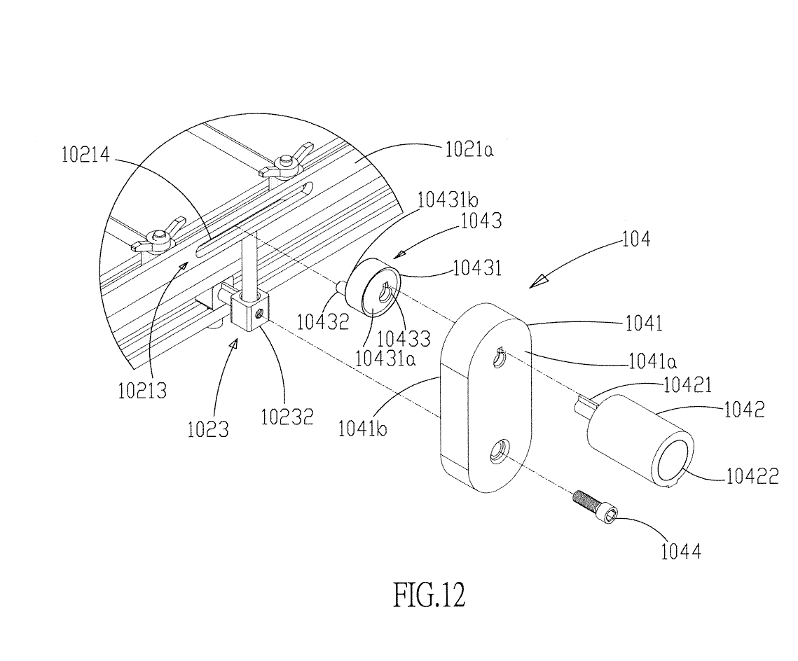

FIG. 12 shows an assembly diagram of the driving module assembled on the movable frame according to the third embodiment of the present disclosure. As shown in the figure, each driving module 104 comprises a fixing base 1041, an actuator 1042, and a driving member 1043. The fixing base 1041 has a first surface 1041a and a second surface 1041b. The actuator 1042 is disposed on the first surface 1041a and includes a spindle passing through the fixing base 1041. The driving member 1043 is disposed on the second surface 1041b of the fixing base 1041 and connected with the spindle 10421. Thereby, the spindle 10421 of the actuator 1042 drives the driving member 1043 to rotate. In addition, the driving member 1043 has a main driving part 10431 and a convex part 10432. According to the present embodiment, the main driving part 10431 is a cylinder having a first surface 10431a and a second surface 10431b. The first surface 10431a has a connecting part 10433 at the center. The connecting part 10433 is connected with the spindle 10421 of the actuator 1042. The convex part 10432 extends outward from the second surface 10431b.

When the driving module 104 is disposed on the first side 1021a of the corresponding frame 1021, the first side 1021a of the frame 1021 has a third installation part 10213, which has a second penetrating groove 10214. The second groove 10214 penetrates the first side 1021a of the frame 1021 and is perpendicular to the first penetrating groove 10212 of the second installation part 10211. The convex part 10432 on the driving member 1043 of the driving module 104 passes through the second penetrating groove 10214. Besides, the fixing base 1041 is fastened to the second connecting part 10232 of the corresponding fixing member 1023 by using a third fastening member 1044 for fixing the driving module 104 to the carrying platform 101. Of course, the fixing base 1041 can also be fastened to the carrying platform 101 via the third fastening member 1044 for disposing the fixing base 1041 to the carrying platform 101. The details will not be described again. The actuator 1042 has a control circuit 10422 connected electrically with the monitoring device 12. Thereby, the monitoring device 12 can activate the driving module 104, and thus activating the multi-touch testing fixture 10 for performing test.

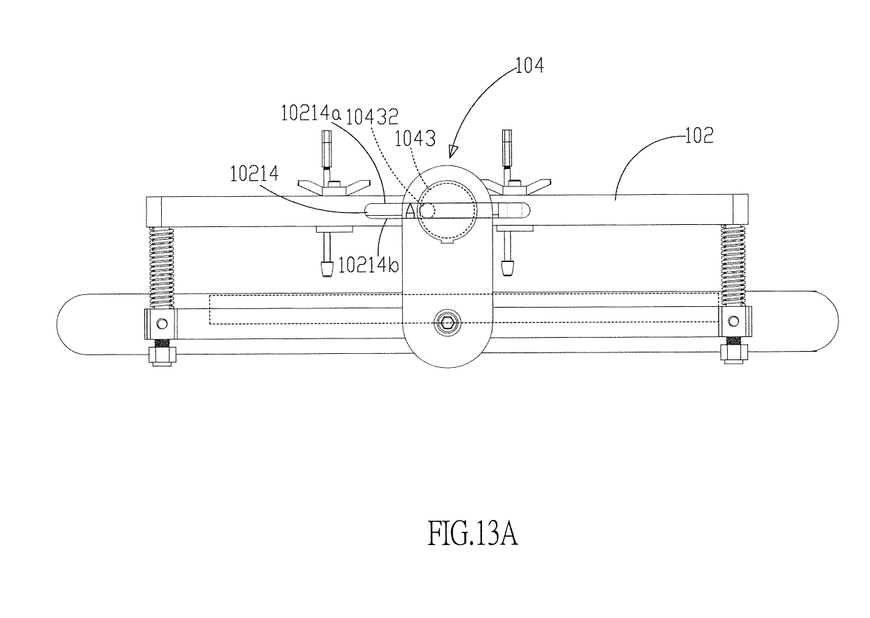

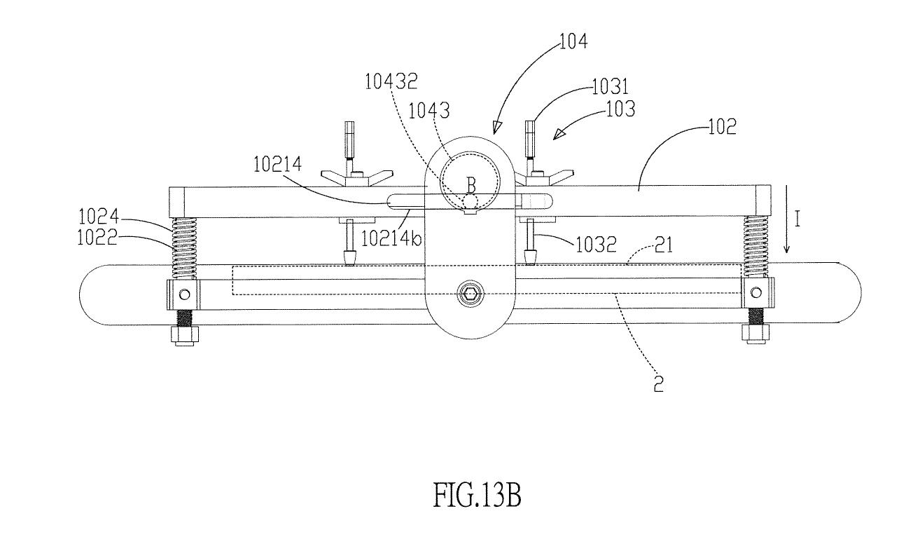

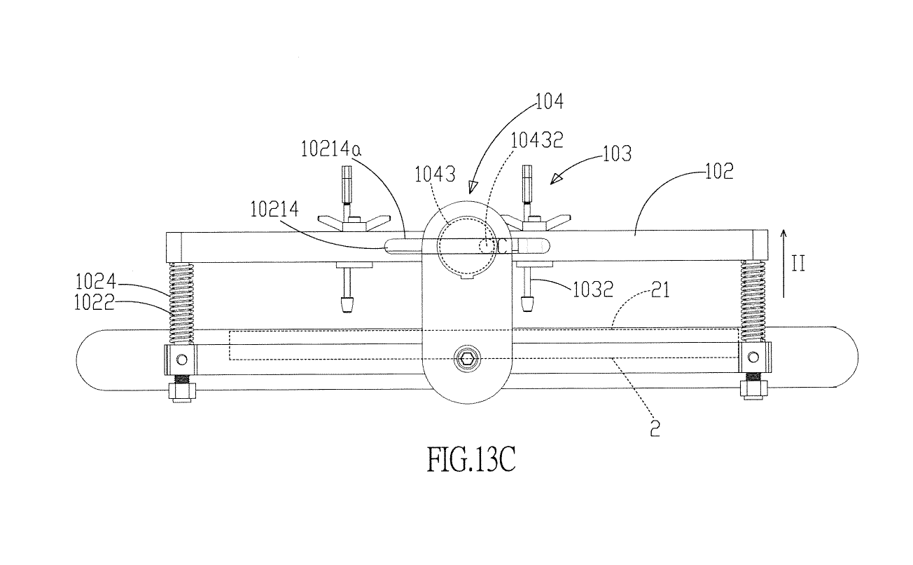

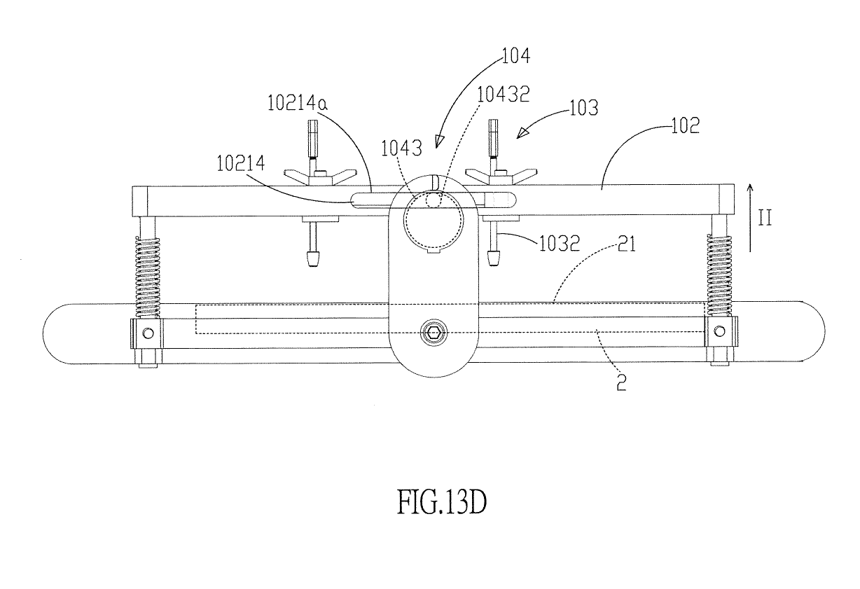

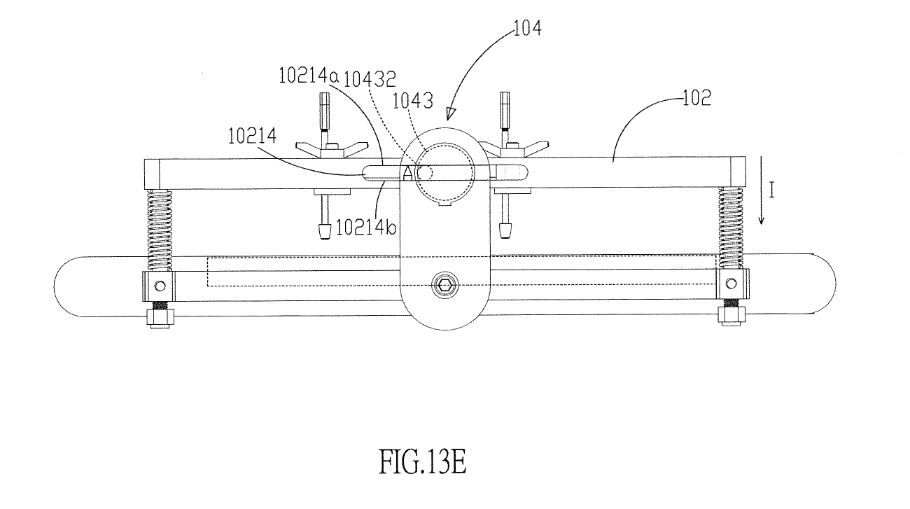

FIGS. 13A to 13E show usage status diagrams of the testing fixture according to the third embodiment of the present disclosure. As shown in the figures, first, set the initial position A of the convex part 10432 on the driving member 1043 of the driving module 104. The convex part 10432 is located at the center of the second penetrating groove 10214 and against to the top sidewall 10214a and the bottom sidewall 10214b of the second penetrating groove 10214. At this moment, the convex part 10432 will not drive the frame to move.

Next, the monitoring device 12 activates the actuator 1042 of the driving module 104. The actuator 1042 drives the driving member 1043 to rotate counterclockwise. The position of the convex part 10432 of the driving member 1043 changes from A to B. The convex part 10432 continues to push the bottom sidewall 10214b of the second penetrating groove 10214 for driving the movable frame 102 to move towards the first direction I. In addition, the plurality of elastic members 1024 of the plurality of sliding pillars 1022 disposed at the movable frame 102 are in a compressed state. As the movable frame 102 moves towards the first direction I, the plurality of test heads 103 disposed at the movable frame 102 also move towards the first direction I. The plurality of pressing parts 1032 of the plurality of test heads 103 press the touch region 21 of the device under test 2. Then the plurality of pressing parts 1032 are drawn into the corresponding main part 1031 and compress the elastic parts 1033 in the accommodating trench 10311, as shown in FIG. 11, for emulating the touch condition by a human. When the plurality of pressing parts 1032 presses the touch region 21 of the device under test 2, the device under test 2 generates a signal and transmits the signal to the monitoring device 12. The monitoring device 12 judges if the device under test 2 passes the test according to the signal.

Afterwards, the actuator 1042 continues to drive the driving member 1043 to rotate counterclockwise; the position of the convex part 10432 of the driving member 1043 changes from B to C. The convex part 10432 is against the top sidewall 10214a for driving the movable frame 102 to move towards the second direction II and recover to its original position. At this time, the elastic members 1024 of the plurality of sliding pillars 1022 disposed at the movable frame 102 produce restoring forces due to the compression and this assisting the driving module 104 to drive the movable frame 102 to recover to its original position. Meanwhile, the plurality of pressing parts 1032 of the plurality of test heads 103 move away from the device under test 2. The elastic part 1033 in each test head 103 produces a restoring force due to the compression and pushes the pressing part 1032 out of the main part 1031 for recovering the pressing part 1032 to its original position.

Then, the actuator 1042 continues to drive the driving member 1043 to rotate counterclockwise. The position of the convex part 10432 of the driving member 1043 moves from C to D. The convex part 10432 continues to push the top sidewall 10214a of the second penetrating groove 10214 and continues to drive the movable frame 102 to move towards the second direction II. Next, the actuator 1042 continues to drive the driving member 1043 to rotate counterclockwise. The position of the convex part 10432 of the driving member 1043 moves from D to A. The convex part 10432 pushes the bottom sidewall 10214b of the second penetrating groove 10214, and thus driving the movable frame 102 to move towards the first direction I and recovering the movable frame 102 to its original position. Accordingly, the multi-touch testing fixture 10 continues to repeat the steps described above for performing multi-touch testing on the device under test 2.

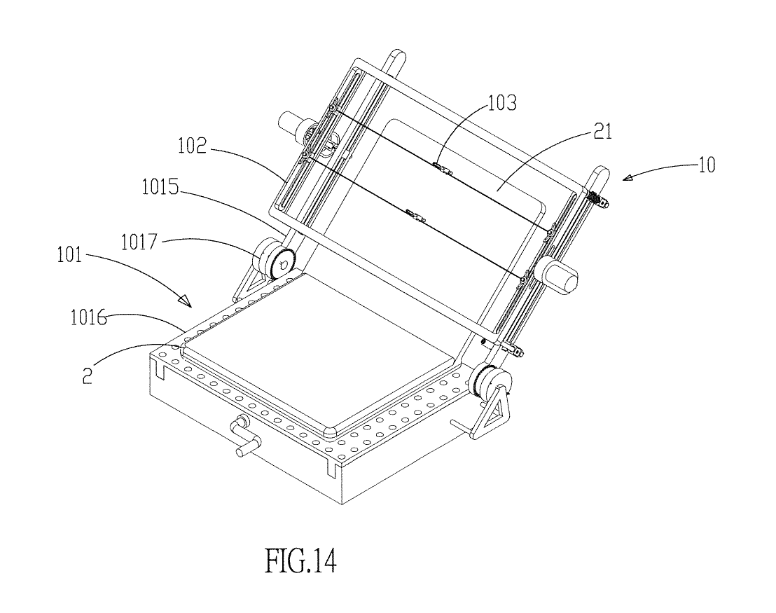

FIG. 14 shows a schematic diagram of the testing fixture according the fourth embodiment of the present disclosure. As shown in the figure, the difference between the multi-touch testing fixture 10 according to the present embodiment and the one according to the previous embodiment is that the carrying platform 101 according to the present embodiment has a first carrying platform 1015 and a second carrying platform 1016. The first carrying platform 1015 is connected pivotally to the second carrying platform 1016. Thereby, the first carrying platform 1015 can flip with respect to the second carrying platform 1016. In addition, the carrying platform 101 according to the present embodiment further comprises an angle adjusting mechanism 1017 disposed at the junction between the first and second carrying platforms 1015, 1016 for controlling the flipping angle of the first carrying platform 1015 with respect to the second carrying platform 1016. The angle adjusting mechanism 1017 can be a gear mechanism; other methods can also be adopted for adjusting the angle. The details will not be described again.

While using the carrying platform 101 according to the present embodiment, the second carrying platform 1016 carries the device under test 2, and the touch region 21 is located on the first carrying platform 1015. The angle between the first and second carrying platforms 1015, 1016 is adjusted according to the angle between the touch region 21 and the device under test 2. Then, dispose the movable 102 having the plurality of test head 103 to the first carrying platform 1015 and corresponding to the touch region 21. Besides, the plurality of test heads 103 are made perpendicular to the surface of the touch region 21. The connecting method between the movable frame 102 and the first carrying platform 1015 is the same as the one according to the third embodiment. Hence, the details will not be described again. Moreover, current swing testing machines has this kind of carrying platform 101. Thereby, the multi-touch testing fixture according to the present disclosure can be disposed directly to current swing testing machines for testing the opening and closing functionality as well as the multi-touch performance simultaneously.

Accordingly, the present disclosure conforms to the legal requirements owing to its novelty, nonobviousness, and utility. However, the foregoing description is only embodiments of the present disclosure, not used to limit the scope and range of the present disclosure. Those equivalent changes or modifications made according to the shape, structure, feature, or spirit described in the claims of the present disclosure are included in the appended claims of the present disclosure.

1. A multi-touch testing fixture, comprising:
a carrying platform, carrying a device under test;
a movable frame, disposed on said carrying platform;
a plurality of test heads, disposed at said movable frame, and corresponding a touch region of said device under test; and
at least a driving module, driving said movable frame to do reciprocating motion, and said plurality of test heads pressing said touch region simultaneously along with the movement of said movable frame.

2. The multi-touch testing fixture of claim 1, wherein said movable frame comprises:
a frame, located above said carrying platform;
a plurality of sliding pillars, disposed at said frame;
a plurality of fixing members, dispose at said carrying platform, and said plurality of sliding pillars passing through and sliding on said corresponding fixing members, respectively;
a plurality of elastic members, put around said corresponding sliding pillars, respectively, and located between said corresponding fixing members and said frame; and
at least a positioning member, disposed at said frame, and said plurality of test head disposed at said positioning member and corresponding to said touch region.

3. The multi-touch testing fixture of claim 2, wherein said movable frame comprises at least a stopping member, disposed at said corresponding sliding pillar, and located below said corresponding fixing member.

4. The multi-touch testing fixture of claim 2, wherein said carrying platform has a pair of first sides, each first side having a first installation part, and said plurality of fixing members disposed in two grooves of said two first installation parts and corresponding to said plurality of sliding pillars.

5. The multi-touch testing fixture of claim 4, wherein each said fixing member comprises:
a first connecting part, disposed at said first installation part; and
a second connecting part, connected to said first connecting part, located outside said carrying platform, and said sliding pillar passing through said second connecting part.

6. The multi-touch testing fixture of claim 4, wherein said frame has a pair of first sides, each said first side having a second installation part, the both ends of said positioning part having a fixing part, respectively, and said two fixing parts fixed in a first penetrating groove of said corresponding second installation part, respectively.

7. The multi-touch testing fixture of claim 1, wherein said driving module comprises:
a fixing base, disposed at said carrying platform;
an actuator, disposed at said fixing base; and
a driving member, disposed at said fixing base, connected with said actuator and said movable frame, said actuator driving said driving member, said driving member driving said movable frame to do reciprocating motion, and said movable frame driving said plurality of test heads to press said device under test.

8. The multi-touch testing fixture of claim 7, wherein said frame has a pair of first sides, each said first side having a third installation part, said driving member having a convex part, and said convex part disposed at a second penetrating groove of said third installation part.

9. The multi-touch testing fixture of claim 2, wherein each said test head comprises, respectively:
a main part, disposed at said positioning member;
a pressing part, passing through said main part; and
an elastic part, disposed in said main part, and against said pressing part.

10. The multi-touch testing fixture of claim 9, wherein said pressing part comprises:
a pressing body, passing through said main part; and
a conductive member, disposed at said pressing body, and corresponding to said touch region.

11. The multi-touch testing fixture of claim 9, wherein said main part has a third connecting part disposed at said positioning member.

12. The multi-touch testing fixture of claim 1, wherein said carrying platform comprises:
a first carrying platform; and
a second carrying platform, connected pivotally to said first carrying platform, carrying said device under test, and said touch region located on said first carrying platform.

13. The multi-touch testing fixture of claim 12, wherein said carrying platform further comprises an angle adjusting mechanism, disposed at the junction between said first carrying platform and said second carrying platform for adjusting the flipping angle of said first carrying platform with respect to said second carrying platform.

14. A multi-touch testing system, comprising:
a multi-touch testing fixture, carrying a device under test; and
a monitoring device, connected electrically to said multi-touch testing fixture and said device under test, activating said multi-touch testing fixture, said multi-touch testing fixture performing multi-touch testing on said device under test, said device under test generating at least a signal and transmitting said signal to said monitoring device, and said monitoring device judging if said device under test passes the test according to said signal.

15. The multi-touch testing system of claim 14, wherein said multi-touch testing fixture comprises:
a carrying platform, carrying said device under test;
a movable frame, disposed on said carrying platform;
a plurality of test heads, disposed at said movable frame, and corresponding a touch region of said device under test; and
at least a driving module, connected electrically with said monitoring device, said monitoring device activating said driving module, said driving module driving said movable frame to do reciprocating motion, and said plurality of test heads pressing said touch region simultaneously along with the movement of said movable frame.

16. The multi-touch testing system of claim 14, wherein said driving module comprises:
a fixing base, disposed at said carrying platform;
an actuator, disposed at said fixing base, and having a control circuit connected electrically with said monitoring device; and
a driving member, disposed at said fixing base, connected with said actuator and said movable frame, said monitoring device activating said actuator via said control circuit, said actuator driving said driving member, said driving member driving said movable frame to do reciprocating motion, and said movable frame driving said plurality of test heads to press said device under test.
